(19) United States
(12) Patent Application Publication
(10) Pub. No.: US 2022/0239104 A1
(43) Pub. Date: Jul. 28, 2022

(54) TRANSACTING NON-TRADITIONAL ELECTRICAL PROPERTIES

(71) Applicant: Faith Technologies, Inc., Menasha, WI (US)

(72) Inventors: Kevin Dennis, Menasha, WI (US); Daniel Anthony Nordloh, Madison, WI (US); Charles Sherman Fredrickson, Neenah, WI (US)

(21) Appl. No.: 17/581,159

(22) Filed: Jan. 21, 2022

Related U.S. Application Data
(60) Provisional application No. 63/140,514, filed on Jan. 22, 2021.

(51) Int. Cl. H02J 3/18; H02J 3/38; G05B 15/02; G06Q 50/06

(52) U.S. Cl. CPC H02J 3/18; G06Q 50/06; G05B 15/02; H02J 3/381

(57) ABSTRACT

An energy-sharing network includes a common bus; a plurality of nodes each electrically connected to the common bus, each node including at least one of a load, a storage device, and a generating capacity and an electric meter electrically connected between the node and the common bus, each electric meter configured to measure an electrical property passed between the common bus and the node over a predesignated time period in a transfer. Each node also includes a local controller in communication with the node's electric meter, wherein the local controllers are in communication and are configured to compare the transfers of the electrical property.

The present application claims priority to the earlier-filed US Provisional Patent Application having Ser. No. 63/140,514, and hereby incorporates the subject matter of the provisional application in its entirety.

### BACKGROUND

The disclosure hereof relates to the field of energy generation, energy storage, and the use, allocation, and transaction of an electrical property in an on- and/or off-grid distribution network, including an electricity distribution network selectively connectable to a local electric distribution grid. More specifically, disclosed herein are apparatus and methods for tracking the generation, storage, and use of an electrical property by one or more nodes to enable financial settlement as between the node owners.

It is known in the art to generate electricity from a variety of renewable sources, such as solar, hydraulic (fluid flow through a turbine), tidal, biomass, Stirling engines, and other sources. The renewable source can be a local source, for example, one or more photovoltaic panels at a location associated with a local use thereof, such as household solar (photovoltaic) panels on a residence or business roof or over a business parking lot, or can be on an industrial scale, for example photovoltaic panel farms, a hydraulic flow resource such as a turbine driven by water flow therethrough, or other such resources. In many cases, the energy generated in the form of electricity is not immediately needed and is used to offset or replace daytime grid energy requirements at a location such as a residence or business, is sold into the grid, or is stored locally to, or remotely from, the generation location. In each case energy is transacted in terms of kilowatt-hours. Each local energy generator or user is dependent upon the utility grid to exchange and transact energy it has generated to or received via the grid, even if such energy is provided to or obtained from another local node.

### SUMMARY

Provided herein are apparatus and methods for tracking the generation, storage, and use of an electrical property by one or more nodes to enable financial settlement as between the node owners, where the node owners can be utilities or non-utility entities. The network includes a common bus to which local nodes are electrically connected. Each local node can include a local bus to which at least one of a load, a storage device, and a generating capacity is connected either directly or through one of a converter, a regulator, and an inverter as shown and described in U.S. Pat. No. 9,093,862, which is incorporated herein by reference to the extent it does not conflict herewith.

The present disclosure is directed to an energy-sharing network including a common bus; a first node electrically connected to the common bus, the first node including at least one of a first load, a first storage device, and a first generating capacity; a first electric meter electrically connected between the first node and the common bus, the first electric meter configured to measure an electrical property passed between the common bus and the first node over a predesignated time period in a first transfer; and a first local controller in communication with the first electric meter. The network also includes a second node electrically connected to the common bus, the second node including at least one of a second load, a second storage device, and a second generating capacity; a second electric meter electrically connected between the second node and the common bus, the second electric meter configured to measure the electrical property passed between the common bus and the second node over a predesignated time period in a second transfer; and a second local controller in communication with the second electric meter, wherein the first and second local controllers are in communication and are configured to compare the first and second transfers of the electrical property.

In another aspect, the present disclosure is directed to an energy-sharing network including a first node electrically connected to the common bus, the first node including at least one of a first load, a first storage device, and a first generating capacity; a first electric meter electrically connected between the first node and the common bus, the first electric meter configured to measure an electrical property passed between the common bus and the first node over a predesignated time period in a first transfer; and a first local controller in communication with the first electric meter. The network also includes an electrical-property-sharing partner node electrically connected to the common bus, the electrical-property-sharing partner node including at least one of an electrical-property-sharing partner load, an electrical-property-sharing partner storage device, and an electrical-property-sharing partner generating capacity, wherein the electrical-property-sharing partner is a non-utility entity; an electrical-property-sharing partner electric meter electrically connected between the electrical-property-sharing partner node and the common bus, the electrical-property-sharing partner electric meter configured to measure the electrical property passed between the common bus and the electrical-property-sharing partner node over a predesignated time period in an electrical-property-sharing partner transfer; and an electrical-property-sharing partner local controller in communication with the electrical-property-sharing partner electric meter, wherein the first and electrical-property-sharing partner local controllers are in communication and are configured to compare the first and electrical-property-sharing partner transfers of the electrical property. The first local controller is configured to automatically or manually negotiate electrical-property-sharing needs and prices with the electrical-property-sharing partner local controller to determine the amount and cost of the electrical property the first node commits to transferring to or from the electrical-property-sharing partner, wherein the first local controller and the electrical-property-sharing partner local controller are configured to subsequently reconcile the cost directly or through a third party using money or units, and wherein the electrical property is one of active power, real power, energy, reactive power, reactive energy, active current, reactive current, apparent power, complex power, and apparent energy.

In still another aspect, the present disclosure is directed to a method for a service provider to maintain voltage, a power factor, or peak power demand at a given customer point of a customer, the method including setting a predetermined voltage range, power factor range, or power demand range at the customer point; determining voltage, the power factor, or the power demand at the customer point; and controlling by the service provider a transfer of an electrical property to or from the customer point to maintain the determined voltage within the predetermined voltage range, the determined power factor within the predetermined power factor range, or the determined power demand within the predetermined power demand range. The method also includes negotiating between the service provider and the customer a value of the transferred electrical property; and reconciling the value directly or through a third party using money or units, wherein the electrical property is one of active power, real power, energy, reactive power, reactive energy, active current, reactive current, apparent power, complex power, and apparent energy.

### BRIEF DESCRIPTION OF THE DRAWINGS

The foregoing and other features and aspects of the present disclosure and the manner of attaining them will become more apparent, and the disclosure itself will be better understood by reference to the following description, appended claims and accompanying drawings, where:

FIG. 1 is a block diagram representation of a multi-node private electrical system with optional utility grid connections for transacting electrical properties according to one aspect of the disclosure; and

FIG. 2 is a block diagram representation of a multi-node electrical system using a utility grid as a common bus for transacting electrical properties according to another aspect of the disclosure.

Repeat use of reference characters in the present specification and drawings is intended to represent the same or analogous features or elements of the present disclosure. The drawings are representational and are not necessarily drawn to scale. Certain proportions thereof might be exaggerated, while others might be minimized.

### DETAILED DESCRIPTION

As used herein, a “node” is any device or group of devices that act as a single entity connected into a distribution system or common bus, and that can perform at least one of absorbing an electrical property (load) from the distribution system, delivering an electrical property (generator) to the distribution system, and both delivering and absorbing an electrical property from the distribution system from time to time.

As used herein, a “local node” is a node that is localized and controlled by the local owner's controller, herein typically, a residence or a commercial or industrial (C&I) site that has a meter between it and the distribution system.

As used herein, a “community node” is a node that is connected to the distribution system and might not be associated with a local node. It can be owned by a third party or by the collection of the local node owners. Typically, it can be a centralized larger distribution system or a set of multiple smaller distribution systems, a collection of individual or groups of electrical property users, electrical property generators, or both with a single or multiple points of connection to a distribution system.

Unless otherwise noted, “electrically connected” or “connected” means two devices, buses, or other components are in electrical contact such that an electrical property can be made to flow from one to the other. The two can be directly connected or connected through one or more intervening devices, buses, or other components. For example, a device electrically connected to a bus can be either directly connected, connected via a converter, inverter, regulator, or other device, or connected through a switch, for example, such that an electrical property can be made to flow from one to the other when the switch is closed.

Unless otherwise noted, “communication” and its variants mean two devices are in contact through ethernet, wireless, or any other suitable transmission technology such that control signals, data, or other information can be transferred between the devices, either directly or through one or more intervening devices.

A distribution system is the electrical interconnection to which each of the nodes are interconnected to allow the transfer of an electrical property between the nodes. One or more distribution systems can be connected to each node via multiple modular and metered interface points at each node. In various aspects, the owner, operator, or user of each node can have a service agreement applicable at the node's point of contact with the rest of the distribution system.

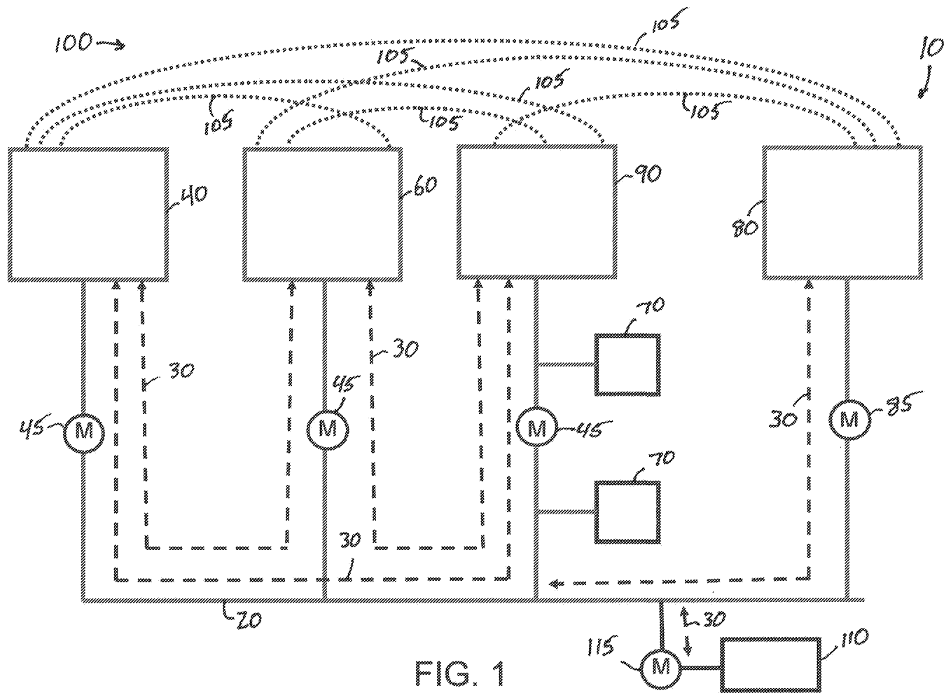

The basic elements of a distribution system 10 in the form of a peer-to-peer network are illustrated in FIG. 1. A common or primary bus 20 is electrically connected to a first local node 40 and a second local node 60. Each local node 40, 60 can include a local bus and at least one of a load, storage device, and generating capacity. Each local node 40, 60 can include at least two of a load, storage device, and generating capacity and can include all three as well as multiples of each. Each local node 40, 60 can use, generate, and/or store an electrical property for use within that node. Each local node 40, 60 can also draw an electrical property from or supply an electrical property to the common bus 20.

It should be noted that in various aspects of the present disclosure, the common bus 20 need not be a single bus but can be multiple physical buses at the same or different voltage or electrical property levels and can be connected directly or via transformers or other suitable apparatus.

Each local and community node can provide and/or receive a flow 30 of an electrical property. In one aspect, for example, the second local node 60, if deficient in an electrical property, can draw the electrical property from the common bus 20 where such electrical property is supplied by the first local node 40. In another aspect, the first local node 40 can draw an electrical property from the common bus 20 where such electrical property is supplied by the second local node 60. In other aspects, the distribution system 10 can have any number of local nodes electrically connected to the common bus 20, where each local node operates independently and can have any combination and number of loads, storage devices, and generating capacities. One or more local nodes can also be a separate distribution system with its own common bus and local nodes such that the overall system includes nested distribution systems. The distribution system 10 is expandable to encompass additional local and community nodes as desired.

The common bus 20 is optionally connected to and electrically disposed behind a utility meter 85, meaning the common bus 20 is separated from the local utility grid 80 by the utility meter 85 typically used to measure an electrical property supplied by the local utility grid 80. Looking at a utility as a supplier, the common bus 20 is downstream from the utility meter 85. Behind the meter can also be used to describe the aspect of the present disclosure in which the common bus 20 is not connected to a utility grid 80. The distribution system 10 can use the utility grid 80 to supply an electrical property to the common bus 20 when the local nodes in total are not supplying sufficient electrical property to meet demand within the nodes. The utility grid 80 can also provide and/or receive a flow 30 of an electrical property.

The distribution system 10 can also optionally include a community node 90 electrically connected to the common bus 20. The community node 90 includes one or more of a community load, community storage, and community generating capacity. Because these are electrically connected directly to the common bus 20, they are essentially shared by the local nodes.

Each local node 40, 60 and community node 90 is optionally connected to the common bus 20 through an electrical meter 45. In this manner, the electrical property supplied to or drawn from the common bus 20 by each local node 40, 60, community node 90, and grid connection can be measured and accounted for in a transactional system 100 as described below.

The distribution system 10 can also optionally include third-party nodes 70, each including at least one of a load, storage device, and generating capacity. Each third-party node 70 can include at least two of a load, storage device, and generating capacity and can include all three as well as multiples of each. Each third-party node 70 can have a service agreement applicable at the node's point of contact with the rest of the distribution system 10.

The distribution system 10 can also optionally be electrically connected to other distribution system, utilities, utility customers, and third-party networks 110, preferably through a meter 115 to participate in the transactional system 100 described herein.

In these aspects, the common bus 20 is an AC bus. Each local node can include an AC bus, a DC bus, or both. Interconnections between the common bus 20 and local nodes 40, 60 can include an appropriate interface device to match AC versus DC, voltage levels, or power, phase, and frequency as needed.

In these aspects, the distribution system 10 is a private electrical network enabling direct electrical property trading behind the utility grid meter 85 with the goal of obtaining the lowest cost electrical property available to a user. The system creates an open market with multiple trading partners connected by one common bus link with an optional utility back up to achieve low costs and electrical property security. The system also allows the users to sell excess electrical property to the network at high rates and purchase excess from the network at low rates as compared to the utility grid 80. With the proper protocols in place, residential users can be combined with commercial and industrial users on the same common bus link. Multiple sources of back up electrical property are available at low cost and with full redundancy. Electrical property sharing can be optimized through manual or automatic peer-to-peer negotiation of rates and electrical property needs, including consideration of node capacity, load demand, and pricing of multiple independent sources.

Such negotiations are conventionally performed only between a non-utility entity owner or operator of a local node and a utility operator, and only in terms of the electrical property of energy as measured in kilowatt-hours. The present disclosure, however, describes an apparatus and method for negotiating between a non-utility entity owner or operator and a utility operator, between non-utility entity owners or operators, between a group of non-utility entity owners or operators and a utility operator, and between groups of non-utility entity owners or operators. A non-utility entity can be a residence, a business, a neighborhood, an independent system operator; an independent electrical property provider (IEPP), user, producer, or operator; a peer-to-peer network; an independent reactive power producer (IRPP); an independent electrical property consumer (IEPC); or any other suitable entity that operates independently and has any combination and number of loads, storage devices, and generating capacities.

In addition, the parties can negotiate in terms of the conventional electrical property of energy as measured in kilowatt-hours, but can alternatively negotiate in terms of any of a number of other electrical properties including active power, real power, energy, reactive power, reactive energy, active current, reactive current, apparent power, complex power, and apparent energy. Active and real power are conventionally measured in kilowatts (kW). Energy is typically measured in kilowatt-hours (kWh). Reactive power is conventionally measured in kilovolt-amperes reactive (kVAr). Reactive energy is conventionally measured in kilovolt-amperes reactive hours (kVArh). Active current is conventionally measured in amperes (A), and reactive current is conventionally measured in amperes reactive (Ar). Apparent and complex power are conventionally measured in kilovolt-amperes (kVA). Apparent energy is conventionally measured in kilovolt-ampere-hours (kVAh). Where appropriate, use of the term electrical property can include the associated electrical power or energy being transferred.

In other aspects of the present disclosure, additional distribution systems can be provided behind the utility meter, that is, off of the utility grid, and multiple nodes, where each node can have the ability to provide an electrical property to the distribution system, store an electrical property, and/or use an electrical property from the distribution system, can be connected to each distribution system. Third-party-owned distribution systems and nodes, including the local electric utility company, can optionally be connected to the distribution system. Such connections preferably include a metered point for an electrical property into and from the distribution system. Where the distribution system is a self-supporting microgrid, no connection with an electric utility is required.

Within the distribution system, peer loads and peer electrical property providers, for example a photovoltaic source, and peer electrical property storage are connected at one or more nodes for each user or electrical property supplier (peer) on the system. A peer can be limited, with respect to the peer-to-peer system, only to use an electrical property from the distribution system, only to supply an electrical property to the distribution system, or both use and supply an electrical property with respect to the distribution system, either directly from an energy source, or from storage of the peer.

Within the distribution system, in one aspect a centralized monitoring station tracks the drawing of an electrical property by a node and the supply of an electrical property to the distribution system at a node based on the timing of use or supply, or based on the assigned value of the an electrical property passing into or from the peer-to-peer system, or both, to track electrical property use and thus for each node, assign a net contribution or net use of the electrical property, and a net value thereof, with respect to the local distribution system over a prescribed period of time. The distribution system can have assigned rules that can be changed by the monitoring station, establishing the value of the electrical property therefrom or thereinto at different times. As a result, the net value of an electrical property supplied to each user, or each node, or supplied by each user or each node, can be used to settle in terms of monetary or other compensation between users at the end of a prescribed period.

Additionally, at least one node connecting to the distribution system can include thereon a local controller, which is user settable to establish whether to take an electrical property from the distribution system, or supply the electrical property to the distribution system, based on the nodes need for, or the value of, the electrical property. The local controller can be autonomous, in communication with the centralized monitoring station, a local controller on other nodes(s), or operate in any two or more of these communication modes at different times.

The distribution system provides isolation from utility grid outage susceptibility but can use the utility grid as a back up to supplement the electrical property needs if required. The system provides protection from utility rate structure changes and reduces vulnerability to utility grid issues such as outages, power surges, and transients. Finally, the system meets all utility grid connection requirements at points of interconnect.

An interface device can be one of several interface devices used to couple a generating source, storage device, or load to a local or common electrical bus 20. Interface devices include an AC to DC converter, a regulator, a DC to AC inverter, and a common bus regulator. The AC to DC converter refers to an interface device that converts an AC input to a DC output, for example, a rectification device. In other aspects of the present disclosure the interface device can be a wire, a fuse, a switch, or any other suitable interfacing mechanism.

The regulator refers to an interface device that converts a DC input at a first voltage potential to a DC output at a second voltage potential. This can be a semiconductor switching and regulating device or a meter and a feedback loop at a connection. In this regulator configuration, energy and power flow through the regulator is based on adjustment of a DC operating voltage band on at least one of the two connections to the regulator, and, based on the actual bus voltage, current flows in one or the other direction. The common bus regulator can be a direct connection with an electricity meter providing feedback to a controller with respect to the passage of electricity therethrough. The regulator refers to a power control and conversion device that is configured to enable changing the voltage at the input thereof to a different voltage at the output thereof, and is used with respect to a local node, as well as a common bus connected to a plurality of local nodes.

The DC voltage across the regulator between a local node and the common bus 20 will be maintained to be equal. For the case in which the regulator is configured as a meter and a feedback loop, the voltages on either side of the regulator would be maintained to be equal. Feedback from the meter indicating power transfer therethrough is used to adjust the voltage bands in the distribution system 10 at each local node. When doing this, a controller in the distribution system 10 determines that the local node voltage is too high or too low (depending on the band adjustment) and attempts to increase or decrease the system voltage by pushing power into the common bus or absorbing power from the common bus.

With power feedback in a control loop with the voltage bands, the voltage bands are constantly adjusting to meet a desired set point of x kw of power flow in/out. In this case, converters and regulators in the local node push/pull power from the bus.

The inverter refers to an interface device that converts a DC input to an AC output. Preferably, each converter, inverter, and regulator is also configured between an on and an off mode, where in the on mode power or energy transfer is allowed therethrough, and in the off mode power or energy transfer therethrough is disabled. Alternatively, a switch can be connected between the local node and the converter, inverter, and regulator, at the output of the converter, inverter, and regulator, or combinations thereof. The switch in this case is within the semiconductor device functioning as the converter, regulator, or inverter, and these components are also able to be physically turned off by switching a contactor internal thereto, or just disabling the switching functions therein while the device remains powered, enabling fast response times in the event of a change in conditions requiring a fast transient response.

Each load, storage device, and generating capacity can be connected to the associated local bus through an appropriate interface device. For example, a generating capacity in the form of a photovoltaic (PV) unit will generate DC electrical energy. The interface device connected between the PV unit and the local bus will be a DC to AC inverter if the local bus is an AC bus.

The generating capacity can be of any type known in the art, including but not limited to wind, photovoltaic, hydroelectric, fuel cell, tidal, biofuel, biomass, or other renewable, advanced, or conventional generating sources. Each of these sources generates power that is output as either an AC or a DC voltage with an amplitude suited to the type of generating source. The voltage output from an AC generating source is provided as an input voltage to the power electronics of the AC to DC converter. The power electronics can be configured to convert the voltage from the source to a desired DC voltage level as an output voltage to the local bus. For example, the desired DC voltage level can be 650 volts if the power system connects to a 460-volt utility grid. Alternately, the DC voltage level can be any desired DC voltage, such as 48 volts, that can be required by a specific DC load. The DC voltage level can be allowed to vary within a preset range and selected to provide optimum energy conversion between a generating source and the local bus. Each AC to DC converter can manage unidirectional or bidirectional power flow between the local bus and the energy or power source connected to the AC to DC converter. For example, the AC to DC converter can allow bidirectional power flow between the local node and the utility grid where returning energy and power to the utility grid is possible, while allowing only unidirectional power flow from a generator or wind turbine to the local node.

Those of ordinary skill in the art will recognize that a bidirectional AC to DC converter acts similarly but in reverse to a bidirectional DC to AC inverter and the two terms are sometimes used interchangeably. Further, throughout the examples and alternatives disclosed herein, one of ordinary skill in the art will know to select the appropriate interface device depending on the power conversion, if any, needed and the nature of the electrical property on both side of the interface device.

Additional disconnect, safeguard, and power control and conditioning devices can be connected where needed in the distribution system 10 as is known in the art. For example, the first and second local nodes 40, 60 can include switches between the generating capacity and the interface device.

Similarly, an AC load can be connected to a local node. Such connection can also include a transformer if necessary. Thus, if an AC load enters a regenerative operating condition, the power generated by the AC load can be returned to the local node. Any number and combination of loads can be connected to the system, such that a load can be connected to the local node either directly, through the inverter, through a DC-to-DC regulator, or any combination or multiple thereof.

Likewise, a storage device or another device having a DC voltage potential output or input can be connected to a local node or the common bus 20 through a DC to AC inverter if such local or common bus is an AC bus. The storage device can be a battery, a fuel cell, a flow battery, pumped hydro, thermal mass, inertial mass/flywheel, super capacitors, or any other suitable energy storage device or mechanism. The inverter can also be connected, for example, to a DC load. Each storage device can be made of either a single device or multiple devices connected in series, parallel, or a combination thereof as is known in the art. In some aspects, the local node operates at a first DC voltage level and the storage device operates at a second DC voltage level. Alternately, the local node and the storage device can operate at the same DC voltage level where the regulator controls current flow between the input and the output. Each regulator can manage unidirectional or bidirectional power flow between the local node and the storage device or other DC device connected to the regulator. For example, the regulator can allow bidirectional power flow between the local node and a storage device while allowing unidirectional power flow from a PV array to the local node or from the local node to a DC load.

The distribution system 10 can optionally include a connection to a utility grid to supply the electrical property to the common bus 20 when the local nodes in total are not supplying sufficient electrical property to meet demand within the local nodes. Each local node can optionally include a connection to a utility grid to supply the electrical property to the local node when insufficient electrical property is available to meet demand within a local node. A grid connection can directly supply the common bus 20 if the common bus 20 is an AC bus. A grid connection can also directly supply AC loads.

The local node if DC can be either a single level or a multi-level DC bus. A single level bus includes a first DC rail and a second DC rail. Each DC rail can be, but is not limited to, a single terminal, multiple terminals connected by suitable electrical conductors, or a bus bar. The single level bus establishes one voltage potential between the first and second DC rails. A multi-level DC bus includes the first and second DC rails and further includes at least a third DC rail. The multi-level DC bus establishes at least two different voltage potentials between the DC rails. For example, a multi-level DC bus can include a first DC rail at a positive voltage potential such as 325 volts, a second DC rail at a neutral voltage potential, and a third DC rail at a negative voltage potential such as −325 volts. The net voltage potential between the first and the third DC rails is twice the voltage potential, or 650 volts, as the potential between either of the first or third DC rails and the neutral second DC rail. Thus, three different voltage potentials exist on the multi-level DC bus. Each converter, inverter, and regulator can connect to any of the three voltage potentials according to the requirements of the load, storage device, or generating capacity connected to the respective interface device.

A high-level controller can be connected via a network medium to the distribution system 10, any converter, inverter, and regulator therein, and to a point of charge meter at the entry point of a grid connection. The network medium can include, for example, CAT-5 cable for an Ethernet connection, an industrial network cable, a proprietary cabling connection, one or more routers, switches, or other network devices, a wireless device in communication with both the high-level controller, local controllers, one or more of the interface devices, or any combination thereof. The high-level controller and/or the local controllers can also be connected to a knowledge system. The knowledge system can either be local or remote. The controllers are connected to the knowledge system via the appropriate network medium and either an internal network, such as an intranet, or via an external network, such as the internet, or hard wire connected. Alternatively, communication for control can be a superimposed DC voltage on a DC bus or other multiplexed signaling protocols.

Multiple knowledge systems can be operable to provide information to the controller. A first set of knowledge systems are connected via the internet and a second set of knowledge systems are locally connected to a controller. A first knowledge system can be a weather service. The weather service can provide, for example, forecasts for upcoming weather conditions and provide historical weather data. The controller can be configured to examine historical weather data such as average daily temperatures, sunrise or sunset times, or average rainfall, where the historical weather data forms, at least in part, a past operating state of the distribution system 10. The controller can also be configured to receive the weather forecasts indicating, for example, the expected temperature, the expected wind speed, or the expected level of sunshine over the next few hours or days, where the weather forecast forms, at least in part, a future operating state of the distribution system 10. The remote weather service can also be configured to work in cooperation with a local weather station. The local weather station can include sensors generating signals corresponding to weather conditions proximate the controller. The sensors can measure, for example, wind speed, insolation, rainfall, and the like. These real-time signals can supplement the historical weather data from the weather service.

Another knowledge system can be an energy market. The energy market can be, for example, another local energy grid capable of supplying an electrical property to or accepting an electrical property from the distribution system 10. Optionally, the energy market can be a commercial-level energy storage facility having the ability to supply an electrical property to customers or local electric grids according to demand. The controller can receive data corresponding, for example, to a historical level of supply or demand from the other local energy grid or energy capacity from the energy storage facility. The historical level of supply or demand by the energy market can provide, at least in part, a past operating state of the controller. The energy market can also provide a forecast of expected electrical property supply or demand, where the forecast provides, at least in part, a future operating state of the controller. Further, the controller can receive real-time updates on pricing for an electrical property from the local energy grid or energy storage facility, where the pricing can change in response to the supply and demand for available electrical property.

Still another knowledge system can be the energy company providing an electrical property to the utility grid. The energy company can supply, for example, rate information defining the rate a consumer can pay to receive the electrical property based, for example, on the time of day or based on current electrical property consumption. The utility provider can provide historical or real-time data corresponding to electrical property consumption at a particular facility or within a local region.

Yet another knowledge system can be a remote monitoring facility. The monitoring facility is identified as a remote facility connected via the internet. Optionally, a local monitoring system can also be located near or incorporated within the controller. The monitoring facility can track electrical property flow within the distribution system 10 and provide real-time and/or historical data of the electrical property flow to the controller. The monitoring facility can track, for example, electrical property usage of the loads connected to the distribution system 10 over time, such as over the course of a day, week, month, or longer, and identify trends in electrical property flow. Similarly, the monitoring facility can track electrical property generation by the electrical property sources over time and identify trends in electrical property generation. The monitoring facility can provide the tracked information to the controller, where the tracked information forms, at least in part, a past operating state of the distribution system 10. The monitoring functions can be performed entirely within either the remote monitoring facility or the local monitoring system or, optionally, the monitoring functions can be shared between the two knowledge systems.

Another knowledge system is the common bus knowledge system. The common bus knowledge system includes a router or other device accessible over either the internet, intranet, or a wireless connection to which the controller of each node has access, a controller/computer that interacts with the individual controllers of a node and a memory. An individual having access to the controller can, through the user interface thereof, access the knowledge system and provide, or update, information concerning a currency value or other value at which they are willing to sell an electrical property into the common bus, as well as a currency value or other value at which they are willing to take an electrical property from the common bus. This information can be time dependent, as in the value offered is different at different times of day, on different days, and at different times on different days. The information, once entered, can be modified by the individual with access. The individual with access can also use an algorithm that over time sets the values based in part on the node's usage history. Additionally, the value need not be monetary, and instead could be in the form of exchange units, or portions of units, of the community of the common bus.

An exemplary knowledge system can include one or more user interfaces. The user interface can provide output or receive input from a user and can include a display device and an input interface, including but not limited to, a keypad, a mouse, a touchpad, or a touchscreen. The knowledge system can be located proximate to or incorporated within the distribution system 10. Optionally, the knowledge system can be located remotely from the distribution system 10 and connected via a communication interface and the network medium. The knowledge system includes one or more memory devices to store information related to operation of the hybrid power system as will be discussed in more detail below. The memory devices can be volatile, non-volatile, or a combination thereof. The knowledge system further includes a storage medium, where the storage medium can include fixed or removable storage, such as a magnetic hard disk drive, a solid-state drive, a CD-ROM drive, a DVD-ROM drive, memory card reader, and the like. At least a portion of the storage medium and/or the memory device provides non-transitory storage. The knowledge system further includes a processor operable to execute one or more modules stored on the storage medium and/or in the memory devices. The knowledge system also includes a database stored in the storage medium that contains data that can influence operation of the distribution system 10. The knowledge system is in communication with the controller via the communication interface and the network medium to transmit data to or receive data from the controller. According to one aspect of the disclosure, the knowledge system can be implemented in part or in whole on a separate server, where the server is located, for example, at a facility owned by the manufacturer of the interface devices or by a third party. Optionally, the server can be implemented in part or in whole within the cloud using computing resources on a demand basis.

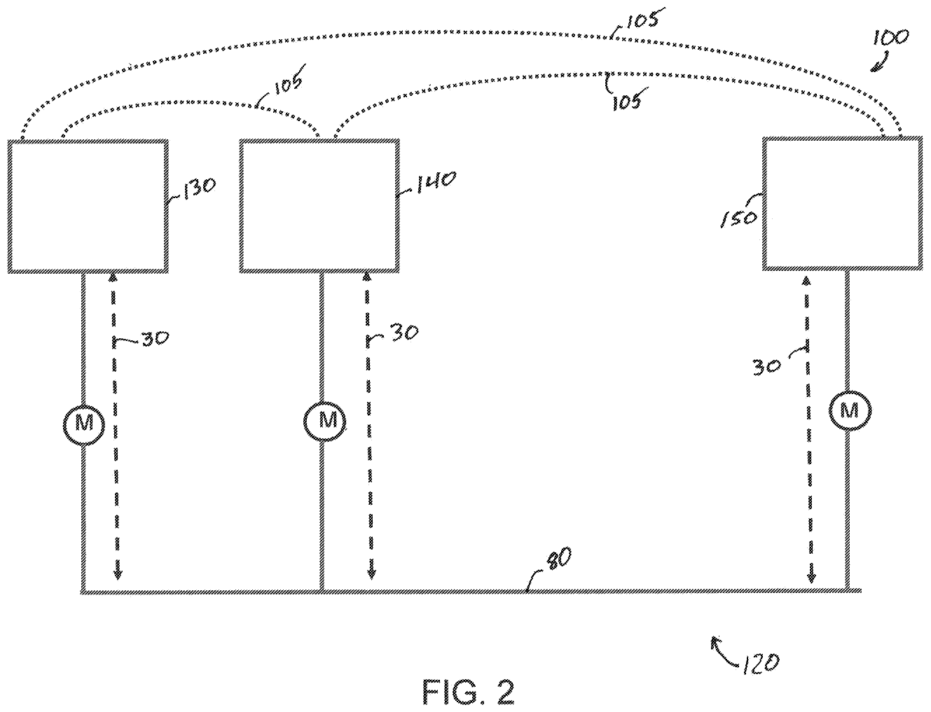

A single high-level controller can be coupled to multiple systems, where each of which becomes a local node connecting to a common bus, such as common bus 20 of FIGS. 1 and 2. Each local node connected to a common bus can also or alternatively be controlled by its own local controller. The point of charge meter is used when a node has a grid connection and AC loads connected at the grid connection, and where there is the desire to provide an electrical property from the distribution system 10 that is sufficient to cover the load exactly so no electrical property is drawn from the utility grid. Further, with non-export requirements, this point of charge meter provides feedback to a controller so the controller can command the grid-tied inverter with a real time electrical property command, so it matches the customer load only with no excess sent to the grid. Additionally, the point of charge meter can provide active and reactive power feedback, power factor, voltage, and other electrical property data to the controller. This feedback to the controller allows the controller to generate compensating electrical property commands. For example, if the power factor is low and customer is being charged for this by the utility, using this feedback the controller will command kvar until the desired power factor is met. The same applies to voltage sags and swells on the grid to help protect customer equipment.

Each controller can include one or more user interfaces. The user interface can provide output or receive input from a user and can include a display device and an input interface, including but not limited to, a keypad, a mouse, a touchpad, or a touchscreen, a cell phone or smart phone application, or an internet- or cloud-based user interface. Each controller can be located proximate to or incorporated within the distribution system 10. Optionally, each controller can be located remotely from the distribution system 10 and connected via a communication interface and the network medium. Each controller includes one or more memory devices to store information regarding operation of the distribution system 10 as discussed in more detail below. The memory devices can be volatile, non-volatile, or a combination thereof. Each controller further includes a storage medium, where the storage medium can include fixed or removable storage, such as a magnetic hard disk drive, a solid-state drive, a CD-ROM drive, a DVD-ROM drive, memory card reader, cloud storage or a network operating center storage, and the like. At least a portion of the storage medium and/or the memory device provides non-transitory storage.

Each controller further includes a processor operable to execute one or more modules stored on the storage medium and/or in the memory devices to generate command signals for each of the interface devices, where the command signals control electrical property flow within each interface device, and, in other than the utility grid connection, enable control of an electrical property to or from a device by setting a voltage band in the interface device using pre-programmed, and thereby controllably-selectable, voltage bands in each interface device to cause the voltage of an electrical-property-providing device to reach the connection to the local node at a higher voltage than the local node and thus cause the electrical property to flow into the local node from the electrical-property-providing device, or cause the voltage at the connection to be less than that of the local node, thereby causing electrical property flow from the local node at the connection point, for example, into and charge a storage device such as a battery.

In the case of a converter between the utility grid and the local node, the controller can also include commands for kw and kvar requirements. Here, the controller sets and when needed changes through the communication link and protocol, voltage bands within the interface devices to cause the electrical property to flow therethrough in a selected direction, or not pass therethrough. Additionally, the controller uses the battery management system internal to the battery to control the flow of current in or out of the battery of the storage device when the state of charge thereof is too high or too low, that is, outside of the desirable operating range thereof. Further, the controller monitors the state of every device with which it is in communication, and stores information regarding operating conditions thereof in storage. Where a fault or trip has occurred with respect to any device, the controller provides notice to a user thereof via e-mail, text, or other communication protocol.

The command signals can be transmitted to the interface devices via the communication interface and the network medium, using any standard communication protocol possible in the transmission environment. According to one aspect of the disclosure, the controller is an industrial computer configured in a rack-mount formation. The interface devices and the controller can each be designed for insertion into the same rack configuration such that a controller can be delivered with the interface devices in a single housing as a stand-alone system. Alternately, the controller can be implemented in part or in whole on a separate server, where the server is located, for example, at a facility owned by the manufacturer of the interface devices. Optionally, the server can be implemented in part or in whole within the cloud using computing resources on a demand basis.

A controller is connected to the distribution system 10 via the appropriate network medium described herein. The controller is in communication with each of the converters and controllers in the distribution system 10 to maintain stable operation of the system.

Multiple exemplary systems 10 with alternatives and varied aspects have been described herein. Various other systems including different combinations of components, generating sources, buses, storage devices, and the like can be used without deviating from the scope of the disclosure. As will be discussed in more detail below, it is further contemplated that multiple systems can each include a separate controller to regulate the components within their respective system, but the controllers can further be in communication with each other to regulate power flow between systems 10.

In operation, the controllers are operable to coordinate electrical property flow within the distribution system 10, between the distribution system 10 and another system, between a distribution system 10 and a utility grid, and between local nodes and common buses. The distribution system 10 can be of a type described in U.S. Pat. Nos. 8,008,808 and 9,093,862, which are incorporated herein by reference to the extent they do not conflict herewith. Optionally, the distribution system 10 can include any combination or multiples of other generating sources, loads, storage devices, and/or interface devices that can be electrically connected in almost any combination provided the appropriate interface devices are used and each local node is metered to monitor electrical property transferred to and from a bus. The controller receives information on the electrical property flow between generating sources, loads, and storage devices, information from the knowledge system, and information relating to the availability of an electrical property on a common bus, a need for the electrical property on a common bus, or the availability of additional storage on or through a common bus.

A local controller will adjust the best (most economical, most weather compatible, etc.) source/load voltage band of each interface device in its node to assure the best asset is being used to meet the requirements of the setpoint/meter feedback. A requesting node has lower priority than a sending node in the sense that a receiving node cannot take more electrical property than a sending node is willing to provide. Priority is set by allowing more voltage range on the sending node than the receiving node. Similarly, a sending node cannot send more than a receiving node is requesting in the sense that a sending node cannot force a receiving node to take an electrical property.

A local controller is in communication with each of the interface devices via the network medium. The interface devices can transmit information related to the level of electrical property being generated by a generating source, drawn by a load, or transferred between a storage device and the local node at a periodic interval to the controller. Optionally, the distribution system 10 can include one or more sensors monitoring the electrical property transferred between each interface device and the local node. According to still another aspect, a first portion of the interface devices can periodically transmit information related to electrical property flow through the device and a second portion of the interface devices can include the sensor.

In response to the information received from the interface devices and from the knowledge system, the local controller generates commands for the interface devices to transfer an electrical property as a result of the information received. Each command can be transmitted via the network medium to the respective interface devices. The interface devices can then monitor and adjust the electrical property being transferred through the interface device to correspond to the desired command generated by the controller.

A common bus can be owned by an entity that is not drawing or supplying an electrical property thereto, by at least one owner of a node or user or supplier of an electrical property to a node, or to the group of node owners or users. In each case, the individual nodes are enabled, as will be described further herein, to set pricing points for the receipt of an electrical property at their node from the common bus, or transmission of an electrical property from their node to the common bus. This information is maintained in a knowledge system, as described hereafter, and is accessible to the controller of the distribution system 10 at each node to allow the controller to configure the devices connected to its local node, and between its local node and the common bus, to allow receipt of an electrical property from the common bus, or from the utility grid if a grid connection is present, as well as transmit an electrical property to the common bus, or to the utility grid if a grid connection is present based on user setting and an internal algorithm configured to predictably reduce the overall cost of the electrical property to the node.

Individual node owners can establish negotiation rules and only when negotiation is complete would an electrical property transfer occur by two or more entities tied into a common distribution system. In such case the settlement would be done directly between the node supplier and the node user automatically via a financial transaction network.

The local controller of a node can connect to the cloud and/or internet and provide metering, reporting, automatic emails, etc., in a manner similar to that of the central controller of an overall network.

The common bus 20 can be connected to the utility grid through an interface device dedicated to that purpose. In this case, the interface device would control access of an electrical property between the utility grid and the common bus 20. Thus, the utility grid-supplied electrical property is behind the meter, for example, on a common bus, before it is received through any node into a load.

Each interface device is able through a controller to transact the exchange of an electrical property with any distribution systems with which it is interconnected. For example, an interface device can transact business with any interface on any node on the common bus, and with the utility grid.

Overall system management infrastructure can be implemented for all peer-to-peer, community, and utility nodes for reconciling and built-in auto pay mechanisms and/or manual invoicing and/or establishment of unit accounts for all members. The transactional system 100 of the present disclosure is described in more detail in U.S. patent application Ser. No. 16/528,515, which is incorporated herein by reference to the extent it does not conflict herewith.

In one aspect, each node includes at least one metered location therein, and each node interface device communicates with an overriding transactional system that reconciles the delivery and consumption of an electrical property at each metered point of that node. In this case, each node will broadcast its willingness to transact its electrical property needs or availability to the overriding transactional system 100 using the interface device thereof, along with terms of the transaction 105 (time, type of transaction, reconciliation methods, etc.). The overriding transactional system 100 resolves a transaction 105 by comparing offered rates and terms of any node to the offered rates and terms of all other nodes and attempts to find a match. When this “negotiation” is completed, that is, when a match occurs, the overriding transactional system 100 responds to each of the nodes in the transaction 105 with the amount to be transacted, time of the transaction, etc. The revenue meters will then monitor and shared with its node what was transacted as well as the overriding transactional system 100 where it will reconcile the agreement. Each transaction 105 can be via a hard-wired connection, a wireless connection, a cloud connection, or any other suitable means of communication.

In another aspect, each node is connected to a communication network of suitable kind for communication directly between the nodes. Each node broadcasts its ability/desire to buy/sell an electrical property through its interface device. Each node then can transact directly with another node without the need of going through the overriding transactional system 100 if a match occurs. The interface devices of two nodes that have established an exchange agreement create transaction information that contains the same information, and each node will report to the other the revenue metering, a validation, and a reconciliation of the amount of an electrical property transacted.

Further, the transactions 105 can be set to be reconciled per event by means of financial methods and monetary-linked transaction accounts. In another case the transacted amount of an electrical property can be maintained on each node's interface device (after the validation step above and confirmed by each node) and maintained as a running net shared electrical property over a time period. At the end of a predesignated time period this information is used to financially reconcile as among the node users or owners or used to maintain the balance of the “borrowed” electrical property as among the nodes. All the terms for the transaction 105 are established at the time of the negotiation between the nodes. Negotiation is automatic and a node operator, such as the owner or user, establishes the conditions of the negotiation. In addition to setting fixed guidelines for the transaction, a node operator can set a mode that will allow the negotiating devices to use steps to maximize the position with limits established to “not buy/sell” an electrical property up to the limits set by the node operator. Additionally, a node can negotiate with multiple other nodes simultaneously to achieve the best value or price for its sale or purchase of an electrical property.

Information within a node or within a system can be aggregated or offset before it is transacted with another node or system and/or before dispatching appropriate resources or prioritizing asset usage most effectively.

Additionally, as described above, the nodes on a common bus can share their information on a common bus knowledge system. Furthermore, where a transactional system 100 for exchange of an electrical property among the nodes is used, more complex transactions 105 are possible. For example, each node can also offer storage capacity to the other nodes on the common bus, and the value of storing the electrical property for later removal can be financially resolved by the transactional system 100. Likewise, the common bus can offer to store an electrical property for a node on a common storage, and again the transactional system 100 can resolve the value of the transaction 105 to the common bus. In either case, each local interface device of a transacting node will receive information regarding when to send and when to receive the stored electrical property.

Once a node has consummated a transaction 105 with another node, that information is stored in the memory of the nodes of the transaction, and at the agreed upon time, the interface device of the selling node causes the controller thereof to open the connection to the common bus to transmit an electrical property thereto, and at the same time, the buying node opens its connection to the common bus and draws in the electrical property equal to that of the transaction 105 over the transaction time. The selling node can supply the electrical property from any of its resources, including its storage or generating capacity.

As described, each node can receive or deliver an electrical property to any of the connected distribution systems, provided each connected system can absorb, store, or generate the electrical property. An interface device can be configured to employ several methodologies for determining how to manage an electrical property based on various financial and technical reasons, including the spot market pricing for selling. Also, in determining whether to offer to buy or sell an electrical property over the common bus or into the utility grid, the interface device makes the determination regarding when and how much of an electrical property to consume or deliver depending on the forecast of the weather, the node's anticipated load based on information including historical data of the node's electrical property use and the mode set at that node (for example, on vacation). For example, if the node user is on vacation, the need for an electrical property at the node is substantially diminished, and thus the interface operates to maintain little or no stored reserve and attempts to sell as much of the electrical property as possible at the greatest net value without filling the storage capacity of the node. Additionally, where peak power pricing and charging is in effect, the interface device is configurable to use predictive data, based on past use and timing of peak use, to store an electrical property for use during those periods to shave the peak to reduce or eliminate any peak pricing impact on an electrical property drawn from the grid.

Where the buying or selling, or not buying or not selling, determination is being made by the interface device, the interface device considers one or more of the following classes of information: 1) The state of charge of the system; 2) The magnitude of the electrical property consumption/generation in the system; 3) The forecast for electrical property use and generation of the system and a determination of a surplus or shortage based on consumption of the loads and the generation of the electrical property in the system; 4) The electrical property rate at which the node owner or user prefers to deliver or absorb the electrical property, if set; 5) Any other owner- or user-set method including allowing selected generating sources to the local node (PV, AC, etc.) to deliver at a given level; and 6) The cost of electrical property available over the utility grid and the common bus, both currently and in the predictable future.

Additionally, the interface device can be set to transact business with nodes based on different priorities. For example, a node can select a negotiated price on a community-based system such as the transactional system 100. A node interface device can select buying from another node based on the lowest cost, or from a specific node. Additionally, in the case of ties such as two nodes offering the same price or value to buy or sell, priority can be given to the first offer in the system by time of entry, or the transactional system 100 can select randomly or by another non-random method, for example selectively prioritizing different nodes in a sequence of nodes.

Where electrical property supply is greater than demand, the transactional system 100 operates with no limit on an amount purchased by a node. If demand is greater than supply, each node on the common bus 20 is required to supply the electrical property to maintain bus stability. The common bus 20 can also draw on its own community generating or storage to maintain voltage band stability and the total electrical property consumed. Doing so results in operating system cost to each site on the common bus 20, on either a per stirpes or a pro rata basis based on traditional use of the common bus 20. Alternatively, the cost to maintain stability can be billed to the users of the electrical property off of the common bus 20 at the time a stability event occurs.

Some utilities currently impose penalties on customers if the power factor at the utility meter is not within a specific range, in essence charging a customer for reactive power consumption. In other cases, as a condition for acquiring an interconnection permit, some utilities require some customers to use a smart inverter from which the utility can draw reactive power at no benefit to the customer (no transaction 105 or financial value) when needed for grid stability. In still other cases, a utility in the future might charge for power factor, reactive power, or reactive energy measured at the utility point of connection meter.

The distribution system described herein can avoid such charges either by ensuring electrical properties are at the proper levels at the point of connection to the utility grid, or by using a transactional system 100 such as that described herein to account for the flow of such electrical properties. For example, in the aspect of ensuring electrical properties are at the proper levels at the point of connection to the utility grid, all inverters connected to the common bus can be used to maintain an electrical property balance at the common bus, thereby reducing or eliminating the reduction draw from the utility. Also, by controlling electrical property flow into or from the AC bus the inverters can help support the voltage regulation if grid sags or swells are present. In another example, in the aspect of using a transactional system 100, an electrical property can be drawn from or supplied to the utility, with charges and credits accounted for in the transactional system 100 described herein.

In one exemplary aspect, one common utility meter at the point of connection or contact (POC) with the utility is managed for reactive energy, power factor, and voltage regulation. Within the peer-to-peer network community, the connected inverters can produce the reactive power and metered reactive energy can be reconciled based on a determined value within the peer-to-peer network to remove the overall charges from the utility grid. Feedback from the POC meter via the central controller can communicate with local and community nodes to bid capacity for correction to offset the utility charges to the community. Such reactive power resources can provide for a transaction 105 or bid into the utility in a manner similar to frequency regulation with watts.

Traditionally, utility customers have installed reactive power management equipment and techniques to reduce their own consumption. Utilities also add infrastructure to provide reactive power in the system. Such infrastructure can include capacitors, static synchronous compensators (statcoms), and active power filters (APFs). Variable speed drives can have active front ends and can be used as a reactive power generator. Regenerative load backs also have this capability and can be used as reactive power generators. Others include dynamic reactive power compensators (inverters with no generation or battery connected) and synchronous condensers (AC machines with no load and no prime mover, only an exciter field to over/under excite the machine).

To address power quality issues, utilities will switch in, for example, capacitor banks to boost voltage by reactive power injection. This has the effect, however, of making the line voltage high near the capacitor and low away from the capacitor. Further, when reactive power is transferred from generation over transmission and distribution, reactive current still flows. The resistance in the line with this reactive current results in added line losses in the form of real power loss over time or real energy. Therefore, reactive power is best produced near the load that needs the reactive power (for example, motors, transformers, and magnetics). Power transfer also experiences the voltage drop along lines with reactive power contributing to the voltage reduction at a higher ratio than active or real power.

With the present disclosure, existing and future assets in local, community, and third-party nodes can be used in the place of customers and utilities adding more infrastructure to address power quality. The many inverters with capability of using a transactional system 100 production and monitoring allow for the financial transaction 105 of an using a transactional system 100 and creates a market. In a specific example, similar to daytime hours when reactive power injection is needed for voltage stability, the inverters can also be used at night to lighten load voltage regulation by absorbing reactive power to lower voltage.

Traditional assets such as capacitors, synch condensers, statcoms, and APFs continue to exist and will continue to be used to address power quality. The transactional system 100 for buying, selling, and using an electrical property can apply to these as well.

In grid interaction, as more central generation is retired and there are more renewables and variable conditions, utilities can contract with privately controlled reactive power generators and loads to manage grid stability. This adds an additional value stream for the installed equipment in microgrids, renewable systems, energy storage systems, and other devices that have active front ends on the grid side.

Electrical properties have value, and excess inverter capacity can be used to generate electrical properties when not generating real power from photovoltaics or other generating sources.

For the aspects in which there is no utility grid connection, the combination of the inverters connected to the common AC bus can be used to maintain and regulate the common AC bus voltage as well as the node voltages, because the nodes can be connected directly or via a transformer if the nodes are at voltage levels different from the common bus. In this manner, the inverters provide the electrical properties needed for proper operation of the common bus with loads that draw electrical properties. The transactional system 100 can account for supply and use of electrical properties in addition to energy. The electrical properties can be bought and sold in the same manner as watts between nodes of a peer-to-peer network and/or between the peer-to-peer network and a utility.

Within an AC peer-to-peer common bus, electrical properties can transact similarly to power. With electrical property consumption at each node being metered on the AC side, the cost on the peer-to-peer network is based on usage. A peer member can source electrical properties from another peer member to open up the capacity of their own inverter for production, provided other peers have excess capacity in their inverters, giving them the ability to provide electrical properties. The exchange becomes a financial transaction 105 layered on the overall peer network optimization.

The transactional system 100 of the present disclosure can be used to transact any or all of the electrical properties in the same manner as energy is currently transacted between a user and a utility. Of particular usefulness in and with peer-to-peer networks is an exchange market for an electrical property such as reactive power.

In one illustrative example, a community peer-to-peer network has a connection to the utility grid on the AC side. Each participant in the community peer-to-peer network has an inverter connection capable of VAr production. The utility meter is at the community level between the peer-to-peer network and the utility. A first community participant has a poor power factor, causing the peer-to-peer network to draw VArs from the grid, resulting in a charge to the community. That charge to the community can then be passed by the transactional system 100 to the first community participant who created the kVAr draw.

Alternatively, a second community participant uses its VAr production capacity to provide VArs behind the meter. This compensates for the first community participant's kVAr draw and results in a good power factor at the utility meter, thus eliminating the kVAr charge to the community. In this case, the first community participant can transact VArs with the second community participant in a peer-to-peer transaction 105 that can be at a lower cost than that charged by the utility.

The transactional system 100 described herein, while particularly useful in a private peer-to-peer private network, can also be used on a larger scale within or between peer-to-peer networks; utilities; independent system operators; independent electrical property providers (IEPP), users, producers, or operators; independent reactive power producers (IRPP); independent electrical property consumers (IEPC); and any other entity that buys or sells electrical properties in their various forms.

As illustrated in FIG. 2, an alternative hybrid aspect of the distribution system 120 is described where the common bus is replaced by or defined as a utility grid 80, which acts as an AC bus. The distribution system 120 can include generating sources of any type known in the art as described above. Further, the distribution system 120 can include AC loads, DC loads, or a combination thereof.

More specifically, the distribution system 120 can include private nodes 130, 140 and a utility node 150. Each private node 130, 140 can be a residence, a business, a neighborhood, an independent system operator; an IEPP, user, producer, or operator; a peer-to-peer network; an IRPP; an IEPC; or any other suitable entity that operates independently and has any combination and number of loads, storage devices, and generating capacities as described herein. The distribution system 120 can include any number of private and utility nodes. The distribution system 120 can include electrical-property-sharing partners sharing through electrical-property-sharing nodes. Although employing the utility grid 80 instead of a common bus, the distribution system 120 accommodates flow 30 of an electrical property and transactions 105 under a transactional system 100 as described herein. Individual nodes can be connected to the utility grid 80 individually, and thus an interface device in each node can be used to control the flow of an electrical property from, or if allowed, to, the utility grid 80.

The electrical-property-sharing partner as one of an independent system operator; an IEPP, user, producer, or operator; a peer-to-peer network; an IRPP; or an IEPC can be seen as a service provider relative to a customer. The service provider can contract with a customer to meet or ensure a certain property at a customer point. The customer point can be the point of connection to a grid or other network or any other suitable point. In one aspect, the service provided by the service provider through the transfer of an electrical property is voltage regulation. The service provider can regulate voltage at a particular customer point through the transfer in or out of reactive power in real time. In a particular aspect, reactive power and/or reactive energy are not explicitly sold, but instead a service agreement is used to maintain the voltage at that customer point within a predetermined range. This is useful in that it allows a customer with high voltage at its facility, which overconsumes energy and impacts the life of equipment, to control the voltage to save money and equipment wear. Such a service can also be provided to address low voltage, which can also have deleterious effects.

A service provider can maintain voltage at a given customer point by setting a predetermined voltage range at the customer point; measuring voltage at the customer point; controlling a transfer of an electrical property to or from the customer point to maintain the measured voltage within the predetermined voltage range; negotiating between the service provider and the customer a value of the transferred electrical property; and reconciling the value directly or through a third party using money or units, wherein the electrical property is one of active power, real power, energy, reactive power, reactive energy, active current, reactive current, apparent power, complex power, and apparent energy. More specifically, the electrical property can be reactive power or reactive energy.

In another aspect, the service provided by the service provider through the transfer of an electrical property is power factor correction. The service provider can correct the power factor at a particular customer point through the transfer in or out of reactive power in real time. In a particular aspect, reactive power and/or reactive energy are not explicitly sold, but instead a service agreement is used to correct the power factor at that customer point within a predetermined range.

A service provider can maintain a power factor at a given customer point by setting a predetermined power factor range at the customer point; determining the power factor at the customer point; controlling by the service provider a transfer of an electrical property to or from the customer point to maintain the determined power factor within the predetermined power factor range; negotiating between the service provider and the customer a value of the transferred electrical property; and reconciling the value directly or through a third party using money or units, wherein the electrical property is one of active power, real power, energy, reactive power, reactive energy, active current, reactive current, apparent power, complex power, and apparent energy. More specifically, the electrical property can be reactive power or reactive energy.

In still another aspect, the service provided by the service provider through the transfer of an electrical property is peak power demand control. The service provider can control peak demand at a particular customer point through the transfer in or out of power in real time. In a particular aspect, power and/or energy are not explicitly sold, but instead a service agreement is used to control the power factor at that customer point within a predetermined range.

A service provider can control peak power demand at a given customer point by setting a predetermined power demand range at the customer point; determining the power demand at the customer point; controlling by the service provider a transfer of an electrical property to or from the customer point to maintain the determined power demand within the predetermined power demand range; negotiating between the service provider and the customer a value of the transferred electrical property; and reconciling the value directly or through a third party using money or units, wherein the electrical property is one of active power, real power, energy, reactive power, reactive energy, active current, reactive current, apparent power, complex power, and apparent energy. More specifically, the electrical property can be active power or energy.

While the disclosure has been described in detail with respect to specific aspects thereof, it will be appreciated that those skilled in the art, upon attaining understanding of the foregoing will readily appreciate alterations to, variations of, and equivalents to these aspects. Accordingly, the scope of the present disclosure should be assessed as that of the appended claims and any equivalents thereto. Additionally, all combinations and/or sub-combinations of the disclosed aspects, ranges, examples, and alternatives are also contemplated.

What is claimed:

1. An energy-sharing network comprising:
a common bus;
a first node electrically connected to the common bus, the first node including at least one of a first load, a first storage device, and a first generating capacity;
a first electric meter electrically connected between the first node and the common bus, the first electric meter configured to measure an electrical property passed between the common bus and the first node over a predesignated time period in a first transfer;
a first local controller in communication with the first electric meter;
a second node electrically connected to the common bus, the second node including at least one of a second load, a second storage device, and a second generating capacity;
a second electric meter electrically connected between the second node and the common bus, the second electric meter configured to measure the electrical property passed between the common bus and the second node over a predesignated time period in a second transfer; and
a second local controller in communication with the second electric meter, wherein the first and second local controllers are in communication and are configured to compare the first and second transfers of the electrical property.

2. The electrical-property-sharing network of claim 1, wherein the electrical property is one of active power, real power, energy, reactive power, reactive energy, active current, reactive current, apparent power, complex power, and apparent energy.

3. The energy-sharing network of claim 1, wherein the first and second nodes are owned by one or more non-utility entities.

4. The energy-sharing network of claim 3, wherein the common bus is owned by a non-utility entity.

5. The energy-sharing network of claim 3, wherein the common bus is a utility grid.

6. The energy-sharing network of claim 3, wherein the common bus is electrically connected to a utility node, further comprising a utility electric meter electrically connected between the utility node and the common bus, the utility electric meter configured to measure an electrical property passed between the common bus and the utility node over a predesignated time period in a utility transfer, wherein the first and second local controllers are configured to compare the first, second, and utility transfers of the electrical property.

7. The energy-sharing network of claim 6, wherein the utility node is controlled to selectively pass the electrical property to and/or from the common bus based on a pre-designated commitment, wherein the first, second, and utility nodes are configured to subsequently reconcile the cost directly or through a third party using money or units, and wherein the electrical property is one of active power, real power, energy, reactive power, reactive energy, active current, reactive current, apparent power, complex power, and apparent energy.

8. The energy-sharing network of claim 1, wherein the first and second nodes are owned by a utility.

9. The energy-sharing network of claim 1, wherein the first node is owned by a utility and the second node is owned by a non-utility entity.

10. The energy-sharing network of claim 1, wherein the common bus is owned by a non-utility entity.

11. The energy-sharing network of claim 1, wherein the common bus is a utility grid.

12. The energy-sharing network of claim 1, wherein the common bus is a plurality of electrically connected buses.

13. The energy-sharing network of claim 1, wherein one of the first node, second node, and common bus is owned by a non-utility entity, and wherein the non-utility entity is one of an independent system operator; an independent electrical property provider (IEPP), user, producer, or operator; a peer-to-peer network; an independent reactive power producer (IRPP); or an independent electrical property consumer (IEPC).

14. An energy-sharing network comprising:
a first node electrically connected to the common bus, the first node including at least one of a first load, a first storage device, and a first generating capacity;
a first electric meter electrically connected between the first node and the common bus, the first electric meter configured to measure an electrical property passed between the common bus and the first node over a predesignated time period in a first transfer;
a first local controller in communication with the first electric meter;
an electrical-property-sharing partner node electrically connected to the common bus, the electrical-property-sharing partner node including at least one of an electrical-property-sharing partner load, an electrical-property-sharing partner storage device, and an electrical-property-sharing partner generating capacity, wherein the electrical-property-sharing partner is a non-utility entity; and
an electrical-property-sharing partner electric meter electrically connected between the electrical-property-sharing partner node and the common bus, the electrical-property-sharing partner electric meter configured to measure the electrical property passed between the common bus and the electrical-property-sharing partner node over a predesignated time period in an electrical-property-sharing partner transfer; and
an electrical-property-sharing partner local controller in communication with the electrical-property-sharing partner electric meter, wherein the first and electrical-property-sharing partner local controllers are in communication and are configured to compare the first and electrical-property-sharing partner transfers of the electrical property
wherein the first local controller is configured to automatically or manually negotiate electrical-property-sharing needs and prices with the electrical-property-sharing partner local controller to determine the amount and cost of the electrical property the first node commits to transferring to or from the electrical-property-sharing partner, wherein the first local controller and the electrical-property-sharing partner local controller are configured to subsequently reconcile the cost directly or through a third party using money or units, and wherein the electrical property is one of active power, real power, energy, reactive power, reactive energy, active current, reactive current, apparent power, complex power, and apparent energy.

15. The energy-sharing network of claim 14, wherein the non-utility entity is one of an independent system operator; an independent electrical property provider (IEPP), user, producer, or operator; a peer-to-peer network; an independent reactive power producer (IRPP); and an independent electrical property consumer (IEPC).

16. The energy-sharing network of claim 14, wherein the first node is operated by a utility, and wherein the utility and the electrical-property-sharing partner negotiate a value of the transferred electrical property.

17. The energy-sharing network of claim 14, wherein the electrical property is reactive power or reactive energy.

18. A method for a service provider to maintain voltage, a power factor, or peak power demand at a given customer point of a customer, the method comprising:
setting a predetermined voltage range, power factor range, or power demand range at the customer point;
determining voltage, the power factor, or the power demand at the customer point;
controlling by the service provider a transfer of an electrical property to or from the customer point to maintain the determined voltage within the predetermined voltage range, the determined power factor within the predetermined power factor range, or the determined power demand within the predetermined power demand range;
negotiating between the service provider and the customer a value of the transferred electrical property; and
reconciling the value directly or through a third party using money or units, wherein the electrical property is one of active power, real power, energy, reactive power, reactive energy, active current, reactive current, apparent power, complex power, and apparent energy.

19. The method of claim 18, wherein the electrical property is reactive power or reactive energy.

20. The method of claim 18, wherein the electrical property is active power or energy.
